(19) United States
(12) Patent Application Publication
(10) Pub. No.: US 2021/0094086 A1
(43) Pub. Date: Apr. 1, 2021

(54) Center Punch Driver for Positioning a Fastener

(71) Applicant: Michael Edward Laut, Raleigh, NC (US)

(72) Inventor: Michael Edward Laut, Raleigh, NC (US)

(21) Appl. No.: 17/061,533

(22) Filed: Oct. 1, 2020

Related U.S. Application Data
(60) Provisional application No. 62/973,359, filed on Oct. 1, 2019.

(51) Int. Cl. B21D 28/34

(52) U.S. Cl. CPC B21D 28/34; B21D 28/36

(57) ABSTRACT

A punch driver for positioning a bit on a work surface is provided. The punch driver may include a housing having an extension for engagement with a tool and a bit aperture for accepting a bit therethrough. The punch driver may further include a holder for accepting the bit and configured for translation within the housing. A hammer spring may be positioned between the extension and a hammer. A rocker bin may be positioned between the holder and the hammer so that when pressure is applied to the holder, translating the holder away from the bit aperture at least a distance, a hammer end of the rocker pin is repositioned to nest within a rocker cavity of the hammer, permitting translation of the hammer towards the bit aperture and striking the hammer end of the rocker pin for translating the holder and the bit, thereby positioning the bit on a work surface.

### CROSS REFERENCE TO RELATED APPLICATIONS

This application claims the benefit of U.S. Provisional Application No. 62/973,359 file Oct. 1, 2020, which is herein incorporated by reference in its entirety.

### TECHNICAL FIELD

The present disclosure relates generally to a punch driver for positioning and driving a fastener into a work surface. More specifically, the present disclosure relates to a automatic punch driver having a spring-loaded action configured to drive a bit into a fastener for pre-positioning the fastener on a work surface.

### BACKGROUND

Driving fasteners into a surface can be difficult, for both new users and experienced users alike. Fasteners, and screws especially, will spin and slide out of position, particularly on metal surfaces. To solve this problem, workers may try using both hands, which is only partially effective and may not be feasible under certain work conditions, like when at heights upon a ladder. Alternatively, a hole punch and hammer, or automatic center punch may be used. Obviously this requires carrying around additional tools or preparing a surface before attempting to drive the fastener into the surface. Frustration and injury are frequently experienced.

Notwithstanding the ability to use additional tools or labor, there remains a need for a tool which improves the ability of a user to drive a fastener into a work surface using a single tool and a single hand. Disclosed herein are one or more devices and methods that advantageously address these issues.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a punch driver is provided. The punch driver includes: a housing including an extension for engagement with a tool, and including a bit aperture for accepting a bit therethrough; a holder for accepting the bit and configured for translation within the housing; a hammer spring positioned between the extension and a hammer, the hammer defining a cavity and configured for translation within the housing; a rocker pin positioned between the holder and the hammer so that when pressure is applied to the holder, the holder translates towards the extension at least a distance, the rocker pin is repositioned to nest within the cavity of the hammer, permitting translation of the hammer towards the holder for striking the rocker pin and translating the bit.

According to at least another embodiment, the housing includes: a male portion including the extension; a female portion housing at least a portion of the holder; and a central portion extending between the male portion and the female portion, wherein the female portion and central portion are selectively fastened using threads defined by each.

According to at least another embodiment, the punch driver further includes a male screw for selectively fastening the male portion and the central portion, wherein the male portion defines a male aperture therethrough and the male screw is configured to be screwed into the male aperture to engage the central portion.

According to at least another embodiment, the punch driver further includes a ball bearing positioned between the holder and the rocker pin.

According to at least another embodiment, wherein the extension has a hexagonal shape along a length of the extension.

According to at least another embodiment, the punch driver further includes one or more bits.

According to at least another embodiment, wherein the holder defines one or more wings for nestingly engaging and translating along grooves of the housing.

According to at least another embodiment, wherein the holder defines one or more wings for nestingly engaging and translating along grooves of the central portion.

According to at least another embodiment, wherein the holder defines a curved end or pointed end engaged with a flat end of the rocker for pivoting the rocker.

According to at least another embodiment, wherein the rocker defines a flat surface extending to a curved surface for engaging the ball.

According to at least another embodiment, further comprising the tool.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a view of a user driving a fastener into a work surface using a tool equipped with a punch driver according to one or more embodiments of the present invention.

FIG. 2A is a bit and a fastener according to one or more embodiments of the present invention.

FIG. 2B is a exploded view of the punch driver according to one or more embodiments of the present invention.

FIG. 3 is a cross-sectional view of the punch driver according to one or more embodiments of the present invention.

FIG. 4 is an assembled view of the punch driver according to one or more embodiments of the present invention.

FIG. 5 is a perspective view of the holder nestingly engaged with the central portion according to one or more embodiments of the present invention.

FIG. 6 is a perspective view of the interior of the female portion engaged with the holder according to one or more embodiments of the present invention.

FIG. 7 is an view of the holder, ball bearing, rocker and hammer positioned as if they were within the housing according to one or more embodiments of the present invention.

FIG. 8 is a perspective view of the central portion housing a rocker according to one or more embodiments of the present invention.

FIG. 9 is a perspective view of the hammer and hammer cavity according to one or more embodiments of the present invention.

FIG. 10 view of the central female interior and trapezoidal aperture according to one or more embodiments of the present invention.

FIG. 11 is a cross-sectional view of the punch driver according to one or more embodiments of the present invention.

FIG. 12 is a perspective and exploded view of the punch driver according to one or more embodiments of the present invention.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

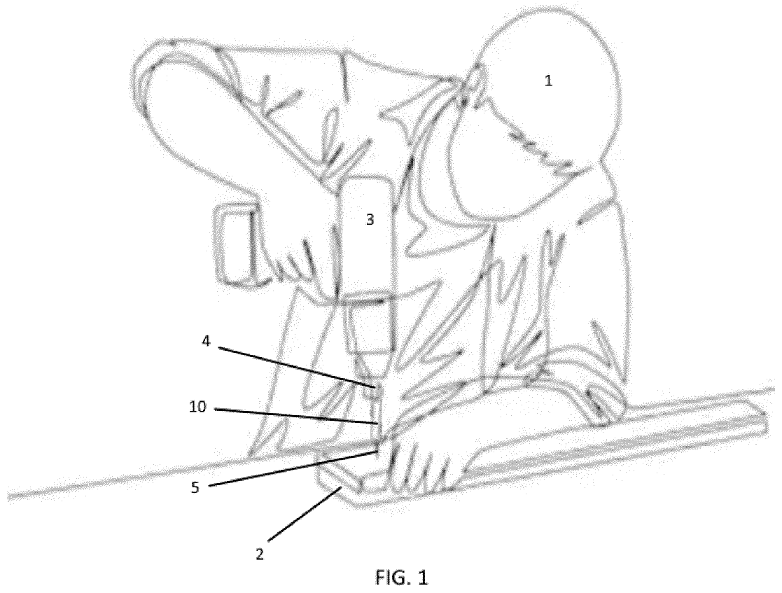

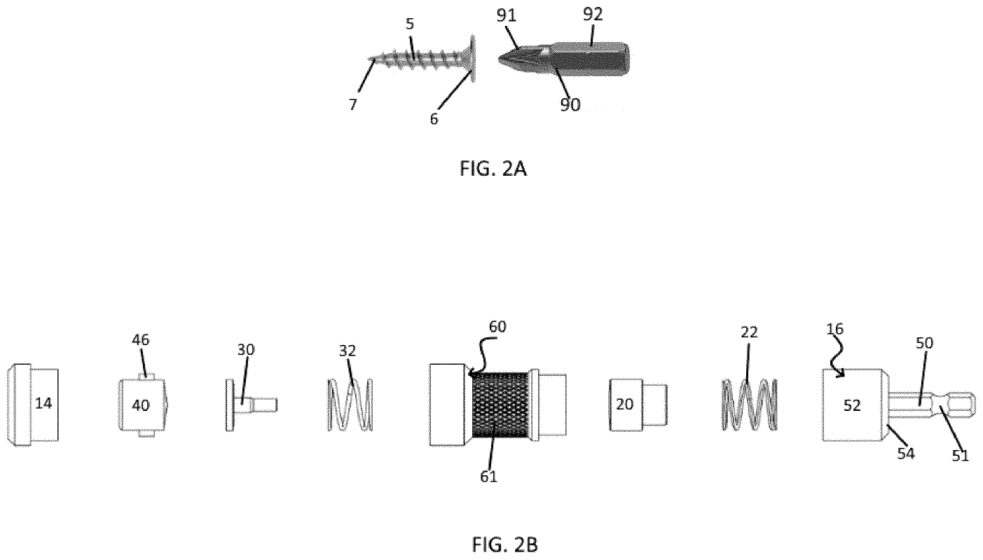

FIG. 1 is a view of a user 1 driving a fastener 5 into a work surface 2 using a tool 3 having a receptacle 4, and a punch driver 10 engaged with the rotating receptacle 4 for applying a punch 11 to the work surface 2 using the fastener 5. FIG. 2A depicts the head 6 and point 7 of the fastener 5, as well as a bit 90 including a working end 91 and holder end 92.

FIG. 2B depicts an exploded view of the punch driver 10 according to one or more embodiments of the invention. The punch driver 10 may be utilized by a user 1 for positioning a bit 90 onto a work surface 2 and/or punching the work surface 2. The user 1 may selectively fasten the punch driver 10 to a tool 3 for using the punch driver 10 in combination with the tool 3. The tool 3 may be an automatic tool, and may include a rotating head 4. The punch driver 10 may be selectively fastened to the rotating head 4 so that the tool 3 retains its original functionality with the added benefit of positioning a bit 90 onto a work surface 2 during or prior to use of the tool 3. Examples of tools 3 that may be utilized include various types of screwdrivers and drills. A bit 90 may be any type of functional end of a tool 3, such as a typical bit, like a flat-head or Phillips-head screwdriver bit, a drill bit, a center punch, or any other type of functional tool end. A fastener 5 may not be used if the purpose is to use a center punch for indenting a surface 2.

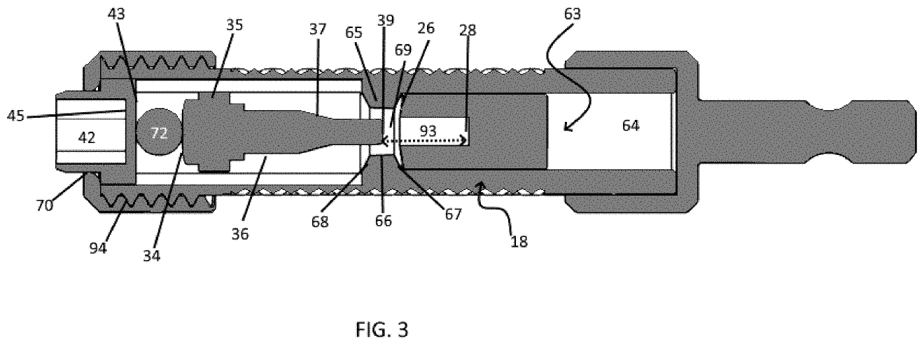

The punch driver 10 may include a housing 12 for containing components of the punch driver 10 therein. The housing 12 may define an extension 50 for engagement with the tool 3, and further define a bit aperture 70 opposite the extension 50 for accepting a bit 90 therethrough. A user 1 may selectively fasten the extension 50 of the housing 12 to the tool 3 (or a receptacle 4 of the tool 3), insert the bit 90 through the bit aperture 70 for selectively fastening the bit 90 to a bit holder 40 housed within the housing 12, and engage a head 6 of a fastener 5 to the working end 91 of the bit 90. By manipulating the tool 3, the user 1 may position a point 7 of the fastener 5 onto a working surface 2, apply pressure from the tool 3, through the punch driver 10, to the fastener 5, thereby translating the bit 90 even further through the bit aperture 70. Turning to FIG. 3, once the bit 90 is translated a distance 93, components and movements within the housing 12 (as described in more detail herein), release pressure from a hammer spring 22 for applying a force to the bit 90 and fastener 5, thereby ‘punching’ the point 7 of the fastener 5 into the working surface 2 and positioning it thereon.

Such advantageous features and methods permit a user 1 to more easily manipulate fasteners 5 relative to working surfaces 2. For example, a user 1 installing a gutter system may find themselves operating on a ladder where use of only one hand is preferable. The user 1 may load the fastener 5, bit 90 and punch driver 10 onto the tool 3 and, using only one hand, push the fastener 5 onto the gutter 2, applying enough pressure to trigger the punch 11 of the punch driver 10 so that the fastener 5 has at least partially punctured or dented the gutter 2. The punch 11 may increase the stability of the fastener 5 relative a work surface 2, permitting the user 1 to more easily manipulate the fastener 5 using the tool 3.

The extension 50 of the housing 12 of the punch driver 10 may take many forms. Many tools 3 include a receptacle 4 for selectively engaging a bit 90. The receptacle 4 may be a cavity or a rotatable head which may be adjusted to fit bits 90 of various sizes and shapes. The extension 50 of the housing 12 may mirror the shapes of bits 90 of the prior art. For example, the extension 50 may be hexagonal, and/or may define an extension groove 51 about a circumference of the extension 50 at some distance along the extension's length. The extension 50 may be selectively fastened with the rest of the housing 12, so that varying extensions 50 may be interchanged, or the extension may be coupled to the rest of the housing 12, or the extension may be unitarily formed with at least another component of the housing 12.

Similarly, the bit aperture 70 and/or holder cavity 42 of the housing 12 of the punch driver 12 may take many forms. The bit aperture 70 and/or holder cavity 42 may be shaped to nestingly engage any bit 90 of the prior art. For example, the bit aperture 70 and/or holder cavity 42 may be hexagonal or circular. Like many receptacles 4 of tools 3, the bit aperture 70 and/or holder cavity 42 may be adjustable to selectively fasten to bits 90 of various shapes and sizes. In some embodiments, the bit aperture 70 is larger than the holder cavity 42 and is not shaped to nestingly engage the bit 90. The bit aperture 70 may include conical-shaped walls for guiding the bit 90 toward the holder cavity 42 for easier engagement. The term “nestingly” is used herein to describe two objects matingly engaging with each other so that the external shape of a first object mirrors the internal shape of a second object, though each has a minor difference in size so that the first object can fit within the second object and their entire circumference is proximal to each other, leaving minimal space between the two.

The housing 12 may be unitarily constructed or constructed in separate pieces. The housing 12 may include and/or define the extension 50, a male portion 14, a female portion 16, and a central portion 18. Each of these pieces 14, 16, 18, 50 may include threads 94 or other frictional elements for connecting with each other, and/or the pieces 14, 16, 18, 50 may be nestingly engagabie or coupled to each other. The male portion 14 of the housing 12 includes or is selectively engaged with the extension 50 for engagement with a tool 3 and, when engaged with the tool 3, is most proximal to the tool 3 as compared to the central portion 18 or female portion 16. The female portion 16 defines the bit aperture 70 and is opposite the male portion 14. The central portion 18 extends between the male portion 14 and the female portion 16.

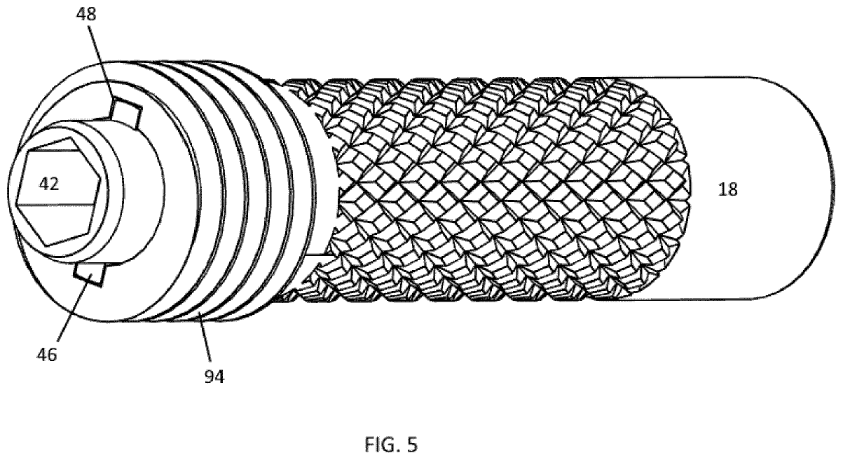

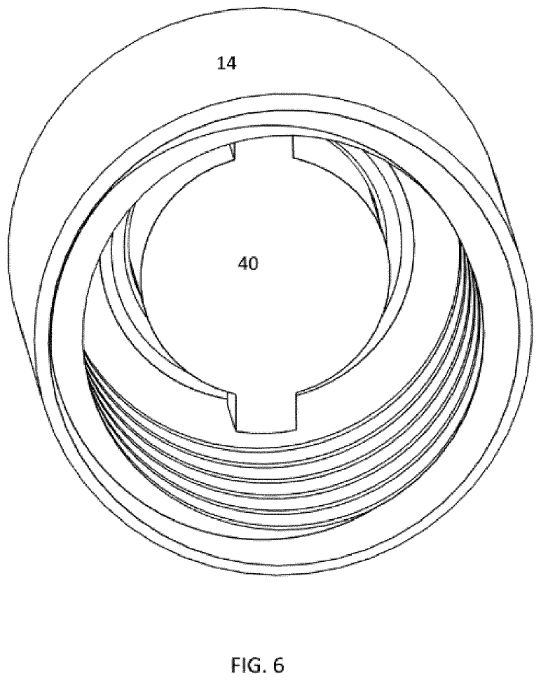

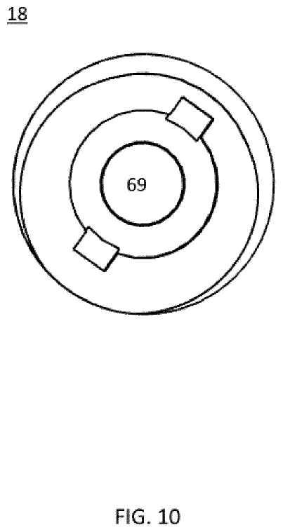

The housing 12 may house several components therein, including but not limited to a hammer 20, hammer spring 22, rocker 30, rocker spring 32, and holder 40. The holder 40 is at least partially housed within the female portion 16 of the housing 12. The holder 40 may be nestingly engaged, and translatable along, a female interior 44 of the female portion 16. In some embodiments, the holder may define one or more wings 46, which may correspond to, nestingly engage with and/or translate along one or more female grooves 48 defined by the female interior 44 or a central female interior 62 of the central portion 18. In other embodiments, two or more wings 46 of the holder 40 may serve to prevent the holder 40 from being expelled through the bit aperture 70 (e.g., see FIGS. 5, 6 and 10 depicting the female portion 16 having threads along the female interior 44 for engaging the central portion 18 and the holder having two wings 46 preventing the holder 40 from being expelled through the bit aperture 70, the two wings 46 also nestingly engaged with two female grooves 48).

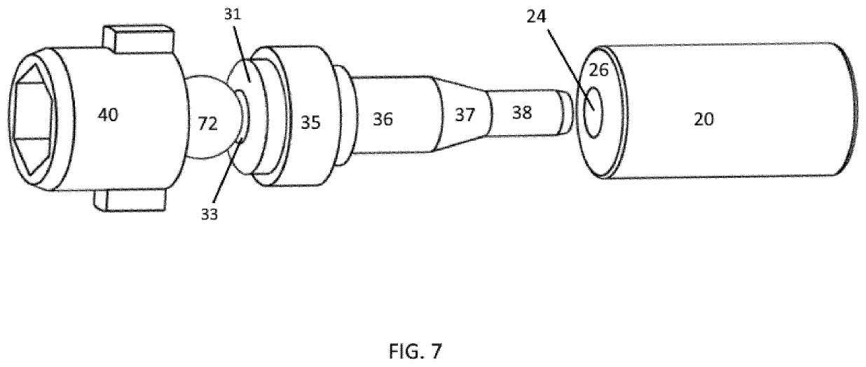

The holder 40 may define a holder end 43 for engaging a rocker pivot 34 of the rocker 30 or a ball bearing 72. The holder end 43 may be substantially flat, or may be conical with a rounded, pointed or flattened apex, or may be a spherical cap. In some embodiments, a ball bearing 72 is positioned between the holder end 43 and the rocker pivot 34. The ball hearing 72 may be spherical. The rocker pivot may be substantially flat or may define a divot. In some embodiments, as depicted in FIG. 7, the rocker pivot 34 may define a flat surface 33 extending into a curved surface 31. The curved surface 31 may be shaped as if two parallel planes sliced a section from a sphere. The combination of the surfaces 31, 33 advantageously ensure that the ball 72 naturally rests in contact with the curved surface 31 as pressure is applied to the rocker 30 through the rocker spring 32 and/or the holder 40 when pressure is applied by the user 1 through manipulation of the tool 3. When the ball 72 rests against the curved surface 31, combined with the pressure being applied, the rocker 30 is pivoted, ensuring that the rocker end 39 engages the hammer end 26 instead of the hammer cavity 24 (at least until sufficient pressure applied by the user 1 translates the holder 40 at least a distance 93).

The rocker 30 may also define a rocker belt 35, a rocker arm 36, a rocker ramp 37 and a rocker pin 38. The central portion 18 may define a central exterior 60, which may define a gripping feature 61 thereon. Further, the central portion 18 may define a central interior 63, which may define a central male interior 64 for housing at least a portion of the hammer 20, a central female interior 62 for housing at least a portion of the rocker 30, and a trapezoidal ridge 65 extending about the central interior 63 between the central male interior 64 and the central female interior 62. The trapezoidal ridge 65 may define a flat side 66, a male side 67 and a female side 68. The hammer 20 may define a hammer cavity 24 and a hammer end 26. The hammer 20 may have a width slightly smaller than the width of the central male interior 64 for nestingly engaging and translating therein.

Moving along the rocker 30 from the female portion 16 towards the male portion 14, the rocker 30 may define: the rocker pivot 34 for engaging the ball bearing 72 or holder end 43 of the holder 40; the rocker belt 35 for providing sufficient width to the rocker 30 to ensure it remains engaged with the ball bearing 72 or holder 40 by engaging the central female interior 62 as the rocker 30 repositions within the housing 12; the rocker arm 36 extending from the rocker belt 35 and having a width slightly smaller than a trapezoidal aperture 69 formed by the flat side 66 of the trapezoidal ride 65; the rocker ramp 37 whose width narrows as it approaches the rocker pin 38 for repositioning the rocker pin 38 to align with the hammer cavity 24 from the hammer end 26 as the rocker ramp 37 engages the trapezoidal ridge 65; and the rocker pin 38 having a width slightly smaller than the width of the hammer cavity 24 for nestingly engaging therein. A rocker spring 32 may be positioned between the rocker belt and the trapezoidal ridge 65. A hammer spring 22 may be positioned between the hammer and a cap 54 of the male portion 14.

Notably the rocker ramp 37, and its gradual repositioning of the rocker 30, may permit the user 1 a tactile sensation so that the user 1 may more easily anticipate the punch 11. Further, the rocker belt 35, which may be substantially cylindrical in shape, may provide advantages over the prior art by permitting easier (and cheaper) manufacturing as compared to the curved rockers of the prior art.

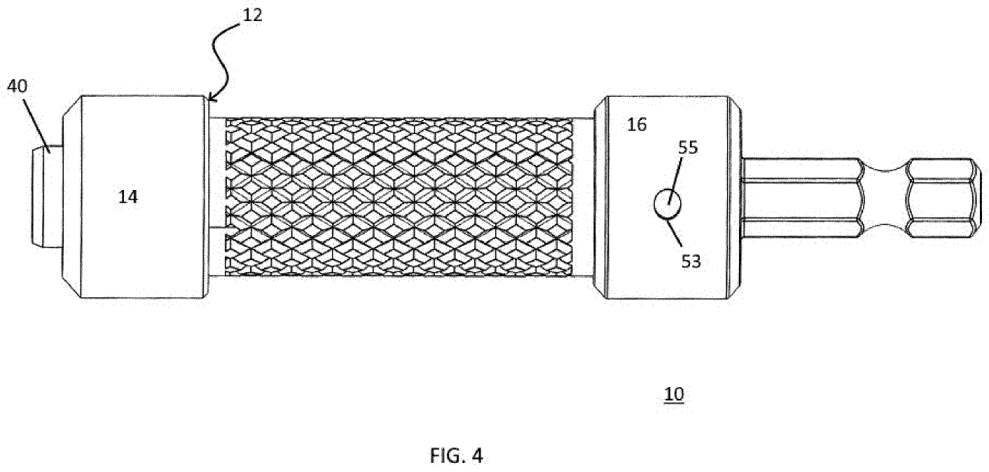

As depicted in FIG. 4, the male portion 14 may define a male exterior 52, which may further define a male aperture 53 having threads for accepting a male screw 55. The male screw 55 may be tightly fastened within the male aperture 53 for engaging the central portion 18 and securing the central portion 18 into position during operation.

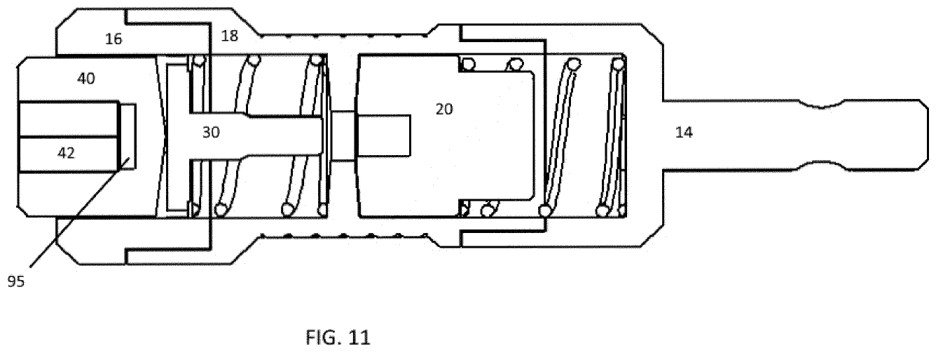

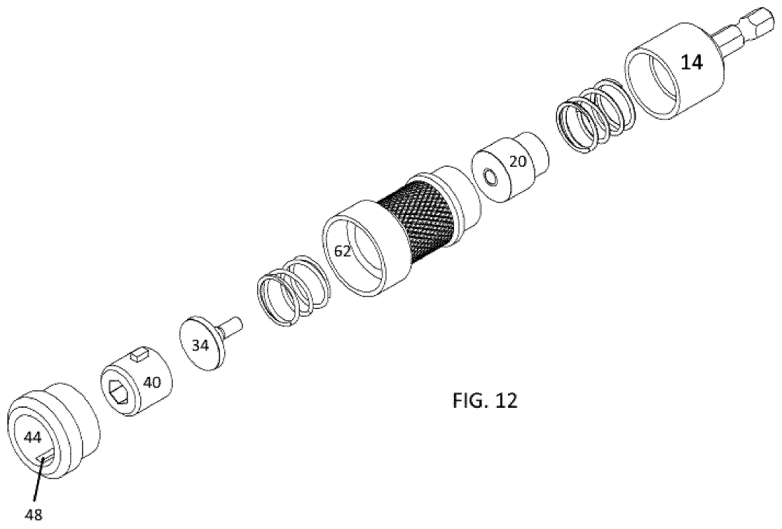

FIGS. 11 and 12 depict alternative embodiments of the punch driver 10. FIG, 11 depicts a magnet 95 housed within the holder floor 45. In other embodiments, the entire holder 40 may be made from ferrous material, or portions of the holder 40 may be magnetic, such as portions of the holder cavity 42. The magnetic qualities may better ensure that the bit 90 remains selectively engaged with the holder 40. In other embodiments, the holder cavity 42 may include frictional surface elements or miniature ball bearings for gripping the bit 90.

One notable difference between the invention described herein and automatic center hole punches of the prior art is that the spike (or punching element) of the prior art is typically free to spin within the housing in which it is positioned. Such spinning would be disadvantageous to the user 1 of the current invention, as it would permit the bit 90 and fastener 5 to spin as well. The incorporation of the wings 46 on the holder 40, whether nesting in the female portion 14 or the central portion 18, prevents the holder 40 from spinning relative the housing 12.

While the housing 12 may be unitarily formed, in embodiments where the female portion 16 and central portion 18 are selectively engaged, the wings 46 of the holder 40 may be nestingly engaged and translatable within the female groove 48 of the central portion 18 (instead of the female groove of the female portion 16, as depicted in FIG. 12). When a rotating receptacle 4 is in use, the user 1 may reverse the rotation of the receptacle 4, and therefore the holder 40 too may be reversed in rotation. If the holder 40 was nestingly engaged with the female portion 16, and the female portion 16 was threaded to the central portion 18, such rotation may de-thread the female portion from the central portion 18.

According to one embodiment of the invention, a method of using the punch driver 10 to position a fastener 6 into a work surface 2 includes translating a bit 90 into the holder cavity 42 until the holder end 92 of the bit 90 engages a holder floor 45 of the holder cavity 42. In some embodiments, the male extension 50 may also be loaded into a tool receptacle 4 while in other embodiments, the punch driver 10 may be used manually. A fastener head 6 may be engaged to the bit's working end 91. The user 1 may manipulate the punch driver 10 so that pressure is applied to the work surface 2 using the fastener point 7. Upon this application of pressure, the holder 50 translates within the housing 12 towards the male portion 14.

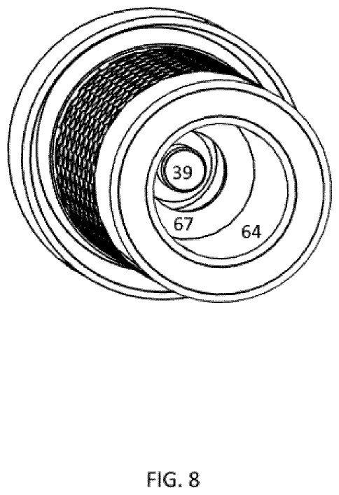

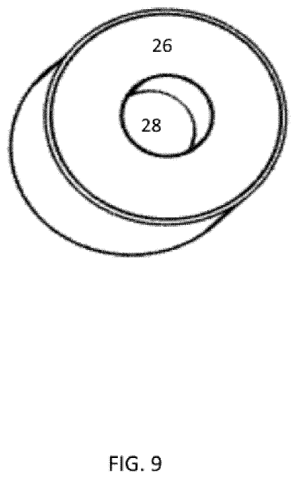

Without the application of pressure upon the holder 50, an end 39 of the rocker pin 38 rests within the trapezoidal aperture 69. Due to gravity, motion and the irregular contacts between the holder 40, ball bearing 72 and/or rocker 30, the rocker end 39 will be resting against the trapezoidal aperture 69. As the holder 50 translates towards the male portion 14, the rocker end 39 is moved towards the hammer end 26 until the rocker end 29 and hammer end 26 are engaged. While not impossible, such a configuration ensures that it is highly improbable that the rocker end 29 immediately enters the hammer cavity 24 without ever having engaged the hammer end 26. Once the hammer end 26 and rocker end 39 are engaged, friction ensures they remain engaged until a directed pressure or leverage disengages the two. FIG. 8 provides a view of the rocker end 39 centered and ready to engage the hammer cavity 24 (shown in FIG. 9).

Such disengagement occurs as the holder 50 (and/or ball bearing 72) translates a distance 93. As the holder 50 approaches the distance 93 of translation, the rocker ramp 37 engages the trapezoidal ridge 65 and begins pivoting the rocker end 39 towards the hammer cavity 24. Upon the holder 50 reaching the distance 93, the rocker arm 36 becomes aligned with (and/or within) the trapezoidal aperture 69 and the rocker end 39 is fully pivoted to align with the hammer cavity 24. Meanwhile, during this translation of the holder 50 (and/or ball bearing 72), the rocker 30 and the hammer 20, the hammer spring 22 and rocker spring 32 are becoming increasing compressed. Once the hammer cavity 24 and the rocker pin 38 are aligned, substantially coextensive, the hammer 20 is translated with force back towards the female portion 16 until the hammer 20 engages the rocker 30, and the rocker 30 too is forced towards the female portion 16, thereby creating a punch 11 by translating the holder 40, bit 90 and fastener 5 so that the fastener point 7 punctures or dents the work surface 2. In some embodiments, it is the hammer floor 28 that contacts the rocker end 39 for creating the punch 11.

As the punch driver 10 is pulled away from the fastener 5, and pressure is relieved from the holder 40, the rocker spring 32 ‘resets’ the punch driver 10 by repositioning the rocker 30, holder 40 and/or ball bearing 72 to their original positions closer to the bit aperture 70.

As used herein, translation means the movement along a straight line. The holder 40 may be translated and rotated, whereas the rocker 30 pivots (or rocks), though the rocker 30 may translate when the rocker end 39 is positioned within the hammer cavity 24.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

The invention claimed is:

1. A punch driver comprising:
a housing including an extension for engagement with a tool, and including a bit aperture for accepting a bit therethrough;
a holder for accepting the bit and configured for translation within the housing;
a hammer spring positioned between the extension and a hammer, the hammer defining a cavity and configured for translation within the housing;
a rocker positioned between the holder and the hammer so that when pressure is applied to the holder, the holder translates towards the extension at least a distance, the rocker is repositioned to nest within the cavity of the hammer, permitting translation of the hammer towards the holder for striking the rocker and translating the bit.

2. The punch driver of claim 1, wherein the housing includes:
a male portion including the extension;
a female portion housing at least a portion of the holder; and
a central portion extending between the male portion and the female portion, wherein the female portion and central portion are selectively fastened using threads defined by each.

3. The punch driver of claim 2, further comprising a male screw for selectively fastening the male portion and the central portion, wherein the male portion defines a male aperture therethrough and the male screw is configured to be screwed into the male aperture to engage the central portion.

4. The punch driver of claim 1, further comprising a ball positioned between the holder and the rocker pin.

5. The punch driver of claim 1, wherein the extension has a hexagonal shape along a length of the extension.

6. The punch driver of claim 1, further comprising one or more bits.

7. The punch driver of claim 1, wherein the holder defines one or more wings for nestingly engaging and translating along grooves of the housing.

8. The punch driver of claim 2, wherein the holder defines one or more wings for nestingly engaging and translating along grooves of the central portion.

9. The punch driver of claim 1, wherein the holder defines a curved end or pointed end engaged with a flat end of the rocker for pivoting the rocker.

10. The punch driver of claim 4, wherein the rocker defines a flat surface extending to a curved surface for engaging the ball.

11. The punch driver of claim 1, further comprising the tool.
